(19) United States
(12) Patent Application Publication
(10) Pub. No.: US 2026/0329906 A1
(43) Pub. Date: Oct. 22, 2026

(54) INFORMATION PROCESSING APPARATUS, RELATED WORD OUTPUT METHOD, AND STORAGE MEDIUM

(71) Applicant: NEC Corporation, Minato-ku, Tokyo (JP)

(72) Inventor: Masafumi OYAMADA, Tokyo (JP)

(73) Assignee: NEC Corporation, Minato-ku, Tokyo (JP)

(21) Appl. No.: 19/104,439

(22) PCT Filed: Aug. 24, 2022
(86) PCT No.: PCT/JP2022/031860

§ 371 Date: Feb. 18, 2025

(51) Int. Cl. G06F 16/334; G06F 16/338; G06F 16/358

(52) U.S. Cl. CPC G06F 16/334; G06F 16/338; G06F 16/358

(57) ABSTRACT

In order to easily collect knowledge related to a matter that interests a user, an information processing apparatus (1) includes: a reception section (11) that receives selection of one or a plurality of extracted words extracted from a target document; and an output control section (12) that causes an output apparatus to output a related word related to the target document and extracted from a related document, the related document being related to each of the one or plurality of extracted words selected and being detected by a retrieval with use of the each of the one or plurality of extracted words.

### TECHNICAL FIELD

The present invention relates to a technology for outputting a keyword related to a document.

### BACKGROUND ART

A technology for detecting a keyword from a document has been proposed. For example, Non-Patent Literature 1 discloses a technology for extracting an important keyword with use of a document summarization model. In the technology disclosed in Non-Patent Literature 1, a group of word vectors similar to embedded vectors in a whole document is extracted. This allows extracting words which capture context.

CITATION LIST

### Non-patent Literature

[Non-patent Literature 1]

Xinnian Liang et. al., “Unsupervised Keyphrase Extraction by Jointly Modeling Local and Global Context”, 15 Sep. 2021

### SUMMARY OF INVENTION

### Technical Problem

However, in the technology disclosed in Non-Patent Literature 1, extracted words which have been extracted from the document are simply presented to a user as they are. As such, the user, for example, separately conducts a search with respect to an extracted word that interests the user among the extracted words, thereby collecting knowledge related to that extracted word. Thus, the conventional technology has room for improvement in that it is not easy to collect knowledge related to a matter that interests the user.

An example aspect of the present invention has been made in view of the above problem, and an example object thereof is to provide a technique that makes it possible to easily collect knowledge related to a matter that interests a user.

### Solution to Problem

An information processing apparatus in accordance with an example aspect of the present invention includes: a reception means that receives selection of one or a plurality of extracted words extracted from a target document; and an output control means that causes an output apparatus to output a related word related to the target document and extracted from a related document, the related document being related to each of the one or plurality of extracted words selected and being detected by a retrieval with use of the each of the one or plurality of extracted words.

A related word output method in accordance with an example aspect of the present invention includes: receiving, by at least one processor, selection of one or a plurality of extracted words extracted from a target document; and causing, by the at least one processor, an output apparatus to output a related word related to the target document and extracted from a related document, the related document being related to each of the one or plurality of extracted words selected and being detected by a retrieval with use of the each of the one or plurality of extracted words.

A related word output program in accordance with an example aspect of the present invention is a related word output program for causing a computer to function as: a reception means that receives selection of one or a plurality of extracted words extracted from a target document; and an output control means that causes an output apparatus to output a related word related to the target document and extracted from a related document, the related document being related to each of the one or plurality of extracted words selected and being detected by a retrieval with use of the each of the one or plurality of extracted words.

### Advantageous Effects of Invention

An example aspect of the present invention makes it possible to easily collect knowledge related to a matter that interests a user.

### BRIEF DESCRIPTION OF DRAWINGS

FIG. 1 is a block diagram illustrating a configuration of an information processing apparatus in accordance with a first example embodiment.

FIG. 2 is a flowchart illustrating a flow of a related word output method in accordance with the first example embodiment.

FIG. 3 is a view illustrating an outline of a related word detection method in accordance with a second example embodiment.

FIG. 4 is a block diagram illustrating a configuration of an information processing apparatus in accordance with the second example embodiment.

FIG. 5 is a view illustrating an example screen in accordance with the second example embodiment to be used by a user in order to designate a granularity.

FIG. 6 is a flowchart illustrating a flow of a process carried out by the information processing apparatus in accordance with the second example embodiment.

FIG. 7 is a view illustrating an example screen displaying a related word, the example screen being outputted by the information processing apparatus in accordance with the second example embodiment.

FIG. 8 is a block diagram illustrating a configuration of an information processing apparatus in accordance with a third example embodiment.

FIG. 9 is a view illustrating an example screen for receiving selection of an extracted word and an example screen displaying a related word, the example screens being outputted by the information processing apparatus in accordance with the third example embodiment.

FIG. 10 is a view illustrating an example screen for receiving selection of an extracted word, the example screen being outputted by the information processing apparatus in accordance with the third example embodiment. FIG. 10 is a view illustrating an example screen outputted by the information processing apparatus.

FIG. 11 is a view illustrating an example of a computer which executes instructions of a program that is software realizing functions of the apparatus according to each of the example embodiments of the present invention.

### EXAMPLE EMBODIMENTS

### First Example Embodiment

The following description will discuss a first example embodiment of the present invention in detail with reference to drawings. The present example embodiment is a basic form of example embodiments described later.

### Configuration of Information Processing Apparatus

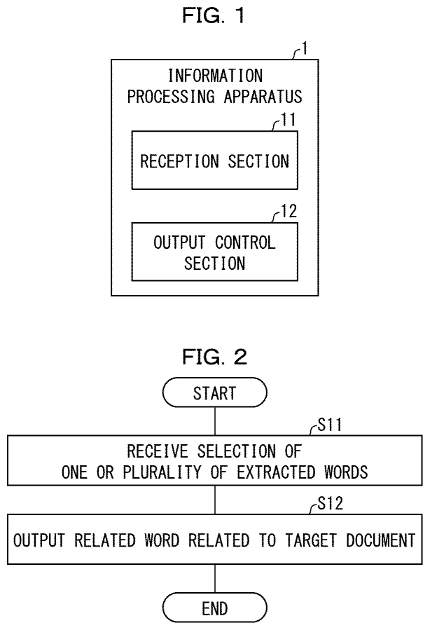

The following will discuss a configuration of an information processing apparatus 1 in accordance with the present example embodiment, with reference to FIG. 1. FIG. 1 is a block diagram illustrating a configuration of the information processing apparatus 1. As illustrated in FIG. 1, the information processing apparatus 1 includes a reception section 11 (reception means) and an output control section 12 (output control means).

The reception section 11 receives selection of one or a plurality of extracted words extracted from a target document. The output control section 12 causes an output apparatus to output a related word related to the target document and extracted from a related document which is related to each of the one or plurality of extracted words selected and which is detected by a retrieval carried out with use of the each of the one or plurality of extracted words selected.

As described above, the information processing apparatus 1 in accordance with the present example embodiment employs a configuration in which the information processing apparatus 1 includes: the reception section 11 that receives selection of one or a plurality of extracted words extracted from a target document; and the output control section 12 that causes an output apparatus to output a related word related to the target document and extracted from a related document which is related to each of the one or plurality of extracted words selected and which is detected by a retrieval carried out with use of the each of the one or plurality of extracted words selected.

In the conventional technology, extracted words extracted from a target document are simply presented to a user as they are. In contrast, according to the above configuration, in a case where a user selects an extracted word that interests the user among extracted words, a related word related to the extracted word which has been selected is outputted. That is, the above configuration makes it possible to easily collect knowledge related to a matter that interests a user.

### Related Word Output Program

The above functions of the information processing apparatus 1 can also be realized by a program. A related word output program in accordance with the present example embodiment causes a computer to function as: a reception means that receives selection of one or a plurality of extracted words extracted from a target document; and an output control means that causes an output apparatus to output a related word related to the target document and extracted from a related document which is related to each of the one or plurality of extracted words selected and which is detected by a retrieval carried out with use of the each of the one or plurality of extracted words selected. The related word output program makes it possible to easily collect knowledge related to a matter that interests a user.

### Flow of Related Word Output Method

The following description will discuss a flow of a related word output method in accordance with the present example embodiment, with reference to FIG. 2. FIG. 2 is a flowchart illustrating the flow of the related word output method. Note that steps of the related word output method may be carried out by a processor of the information processing apparatus 1 or by a processor of another apparatus. Alternatively, the steps may be carried out by processors provided in respective different apparatuses.

In S11, at least one processor receives selection of one or a plurality of extracted words extracted from a target document. In S12, the at least one processor causes an output apparatus to output a related word related to the target document and extracted from a related document which is related to each of the one or plurality of extracted words selected and which is detected by a retrieval carried out with use of the each of the one or plurality of extracted words selected.

As described above, the related word output method in accordance with the present example embodiment includes: receiving, by the at least one processor, selection of one or a plurality of extracted words extracted from a target document; and causing, by the at least one processor, an output apparatus to output a related word related to the target document and extracted from a related document which is related to each of the one or plurality of extracted words selected and which is detected by a retrieval carried out with use of the each of the one or plurality of extracted words. The related word output method makes it possible to easily collect knowledge related to a matter that interests a user.

### Second Example Embodiment

### Outline of Related Word Detection Method

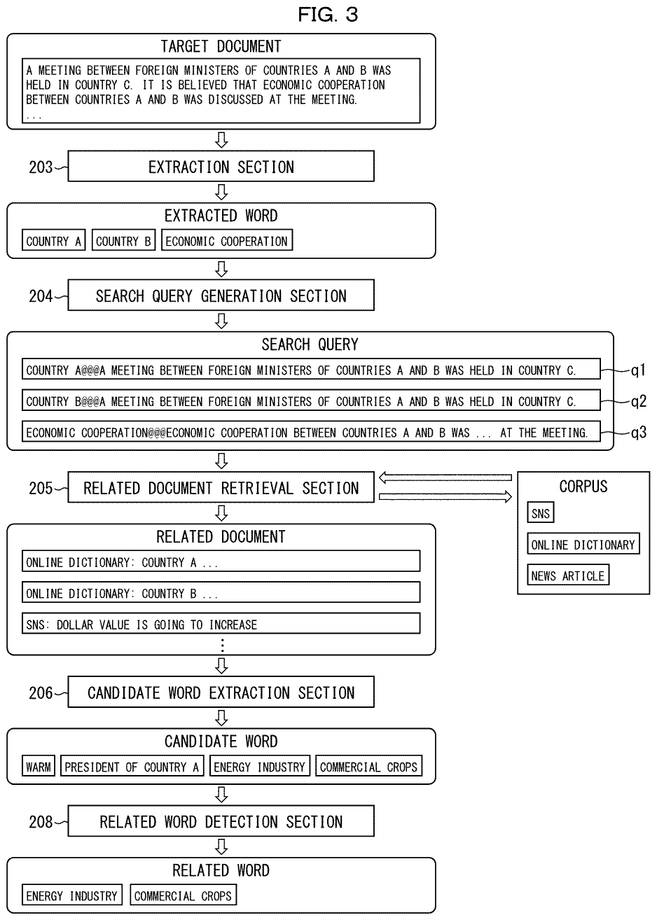

The following will discuss in detail a second example embodiment of the present invention, with reference to drawings. FIG. 3 is a view illustrating an outline of a related word detection method in accordance with the present example embodiment (hereinafter referred to as the present method). The present method is a method of detecting a related word related to a target document. Note here that the target document is a document which includes one or more sentences. The target document may be represented, for example, in the form of unstructured data such as text data, image data, and audio data or in the form of semistructured data in extensible Markup Language (XML) format or the like. The related word is a word which is not included in the target document but is related to the target document. In the example illustrated in FIG. 3, “energy industry” and “commercial crop” are related words.

In the present method, firstly, an extraction section 203 extracts an extracted word from the target document. Note here that the extracted word is a word that is included in the target document. It can be said that the extracted word is an important keyword included in the target document. In the example illustrated in FIG. 3, “country A”, “country B”, and “economic cooperation” are extracted words. The extracted word, for example, is extracted from the target document with use of the document summarization model disclosed in Non-Patent Literature 1 above.

Subsequently, in the present method, a search query generation section 204 generates a search query with use of the extracted word. The search query, for example, is a combination of the extracted word and a sentence containing the extracted word (a sentence extracted from the target document). Note that the search query is not limited to the above example, and may be another query. The search query may be, for example, the extracted word itself.

Subsequently, in the present method, a related document retrieval section 205 retrieves, with use of the search query, a related document from a corpus including a plurality of documents. Note that examples of the corpus encompass an external corpus such as an online dictionary, news articles, a social networking service (SNS), and the like. The corpus may include a reconstructed document generated by reconstruction of a document included in the corpus. The related document is a document related to the extracted word, and is, for example, a document included in the corpus or a part of a document included in the corpus. The related document may be the above-described reconstructed document.

Subsequently, in the present method, a candidate word extraction section 206 extracts candidate words from the related document. The candidate words are words which are included in the related document and which are candidates for the related word. The candidate words, for example, are extracted from the related document with use of the document summarization model disclosed in Non-Patent Literature 1 above. In the example illustrated in FIG. 3, “warm”, “president of country A”, “energy industry”, and “commercial crop” are candidate words.

Subsequently, in the present method, a related word detection section 208 detects a related word from the extracted candidate words. Some of the candidate words have little relevance to the target document. For example, in the example illustrated in FIG. 3, the candidate words “warm” and “president of country A” have little relevance to content of the target document. As such, in the present method, a word related to the target document among the candidate words are detected as the related word. The related word is a word which is not included in the target document but is related to the target document, as described above. The related word can also be said to be a keyword that is thought of in association with the target document. The related word, for example, is outputted by, for example, being displayed on a display and is presented to a user.

### Configuration of Information Processing Apparatus

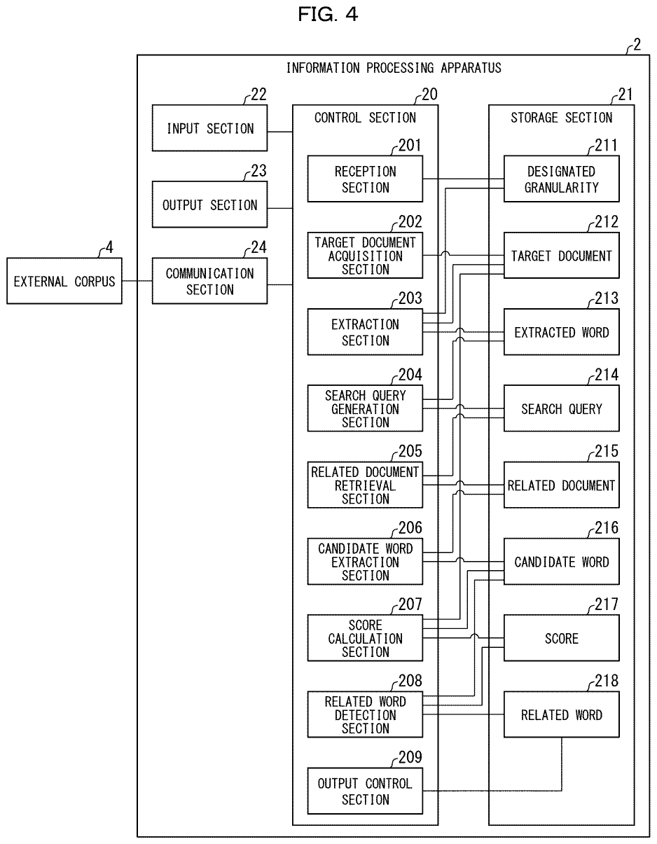

FIG. 4 is a block diagram illustrating a configuration of an information processing apparatus 2 in accordance with the second example embodiment. The information processing apparatus 2 is an apparatus which detects a related word related to a target document. As illustrated in FIG. 4, the information processing apparatus 2 includes a control section 20 which collectively controls sections of the information processing apparatus 2, and a storage section 21 which is a storage apparatus storing therein various data used by the information processing apparatus 2. Further, the information processing apparatus 2 includes an input section 22 which receives a user's input operation with respect to the information processing apparatus 2 and an output section 23 which allows the information processing apparatus 2 to output data. The information processing apparatus 2 includes a communication section 24 which allows the information processing apparatus 2 to communicate with another apparatus via a communication line. The information processing apparatus 2 may be an apparatus dedicated for extraction of a related word, or may be a versatile apparatus that can be used for other purposes as well.

The control section 20 includes a reception section 201 (reception means), a target document acquisition section 202, the extraction section 203 (extraction means), the search query generation section 204 (search query generation means), the related document retrieval section 205 (related document retrieval means), the candidate word extraction section 206 (candidate word extraction means), a score calculation section 207 (score calculation means), the related word detection section 208 (related word detection means), and an output control section 209. The storage section 21 stores therein a designated granularity 211, a target document 212, an extracted word 213, a search query 214, a related document 215, a candidate word 216, a score 217, and a related word 218.

The reception section 201 receives designation of a granularity in a hierarchy. In the present example embodiment, words constituting the target document are each classified in a hierarchical structure. In an example of a classification method, for example, each word is classified by a broad classification, a middle classification, and a detailed classification, and for example, a word “orange” is classified as “food” by the broad classification, “fruit” by the middle classification, and “citrus” by the detailed classification. The granularity in a hierarchy means a hierarchical depth of a word classified in a hierarchical structure. In the above example, the detailed classification is the deepest level in hierarchy (fine classification). Note that the granularity may be replaced with terms such as “depth”, “degree”, “level”, “position”, and “layer”.

The reception section 201 may acquire data which is indicative of the designation and is inputted via the input section 22. Alternatively, the reception section 201 may acquire the data indicative of the designation from a storage location designated by a user of the information processing apparatus 2 (the storage location may be in the storage section 21 of the information processing apparatus 2 or may be a storage apparatus outside the information processing apparatus 2). The reception section 201 causes the received designation of the granularity in a hierarchy to be stored in the storage section 21 as a designated granularity 211. The designated granularity 211 is used during an extraction of an extracted word by the extraction section 203.

The target document acquisition section 202 acquires a target document to be subjected to detection of a related word and causes the acquired target document to be stored in the storage section 21 as a target document 212. The target document acquisition section 202 may acquire a target document that is inputted via the input section 22. Alternatively, the target document acquisition section 202 may acquire a target document from a storage location designated by a user of the information processing apparatus 2 (the storage location may be in the storage section 21 of the information processing apparatus 2 or may be a storage apparatus outside the information processing apparatus 2). The target document is typically text data, but as described above, data in other formats may be used as the target document. That is, the “target document” only needs to include at least one sentence, and can be in any data format.

The extraction section 203 extracts an extracted word from the target document 212 and causes the extracted word to be stored in the storage section 21 as an extracted word 213. The extraction section 203, for example, extracts the extracted word 213 from among words constituting the target document 212, on the basis of the designated granularity 211. Note that the extraction section 203 may extract the extracted word 213 without referring to the designated granularity. A method of extracting the extracted word 213 by the extraction section 203 will be described later. Note that in a case where the target document acquisition section 202 acquires a target document in a data format other than text data, the extraction section 203 may convert the acquired target document into text data and extract an extracted word from the text data.

The search query generation section 204 generates, with use of the extracted word 213 extracted by the extraction section 203, a search query for use in retrieval of a related document and causes the search query to be stored in the storage section 21 as a search query 214. For example, the search query generation section 204 generates a search query 214 that includes (i) the extracted word 213 extracted from the target document 212 and (ii) a sentence included in the target document 212 and containing the extracted word 213. A method of generating the search query 214 by the search query generation section 204 will be described later.

The related document retrieval section 205 retrieves, with use of the search query 214, a related document from a corpus including a plurality of documents. Examples of the corpus to be searched for a related document encompass an external corpus 4 connected via the communication section 24. Note that an internal corpus may be provided in the storage section 21, and in this case, the internal corpus may be subjected to search in place of or in addition to the external corpus 4. The related document retrieval section 205 causes the retrieved related document to be stored in the storage section 21 as a related document 215. A method of retrieving a related document 215 by the related document retrieval section 205 will be described later.

The candidate word extraction section 206 extracts candidate words from the related document 215 and causes the candidate words to be stored in the storage section 21 as candidate words 216. The method of extracting the candidate words 216 by the candidate word extraction section 206 will be described later.

The score calculation section 207 calculates a score that is an index value indicative of a relevance between the target document 212 and each of the candidate words 216, and causes the score to be stored in the storage section 21 as a score 217. For example, the score calculation section 207 calculates, with use of a scorer used for calculation of a score indicative of a relevance between a search word and a website in a search engine, a score that is indicative of a relevance between the target document 212 and each of the candidate words 216.

The related word detection section 208 detects a related word from among the candidate words 216 and causes the related word to be stored in the storage section 21 as a related word 218. The related word detection section 208, for example, detects the related word 218 from among the candidate words 216 on the basis of the score 217 calculated by the score calculation section 207. Note that the technique in which the related word detection section 208 detects the related word 218 is not limited to the above example, and the related word detection section 208 may detect the related word 218 from the candidate words 216 by another technique.

The output control section 209 causes the related word 218 to be outputted to an output apparatus. The output apparatus to which the related word 218 is outputted is, for example, connected to the output section 23 or the communication section 24. Examples of the output apparatus encompass: a display apparatus such as a liquid crystal display or a touch panel; a speaker which outputs audio; and a projector. Note that the output apparatus is not limited to the above examples, and may be another output apparatus.

### Extraction of Extracted Word

The following will describe a method of extraction of the extracted word 213 by the extraction section 203. The extraction section 203, for example, may extract the extracted word 213 from the target document 212 with use of the document summarization model disclosed in Non-Patent Literature 1 above. Further, the extraction section 203 may also extract the extracted word 213 from the target document 212 by the technique of named entity recognition.

In a case of using the technique of named entity recognition, the extraction section 203, for example, uses the technique of named entity recognition to infer a type of each word constituting the target document 212 and extract a word of a specific type (e.g., person name, country name, etc.) as the extracted word 213. Note here that the type of each word indicates a result of classification by named entity classification. In other words, the extraction section 203 may extract, as the extracted word 213, a word of a type that matches a type included in a whitelist. Further, for example, the extraction section 203 may extract, as the extracted word 213, a word whose type is not a specific type among the words constituting the target document 212. In other words, the extraction section 203 may extract, as the extracted word 213, a word of a type other than types that are included in a blacklist.

Further, in a case where the plurality of types are classified in a hierarchical structure, the extraction section 203 may extract, as the extracted word 213, a word of a type corresponding to a specific hierarchical level. The specific hierarchical level may be a predetermined hierarchical level or a hierarchical level corresponding to a designated granularity 211 designated by a user's input operation. For example, in a case where the designated granularity 211 is “middle classification”, the extraction section 203 may extract, as the extracted word 213, a word for which a middle classification is set but no detailed classification is set. In this case, for example, the extraction section 203 may extract a word “apple”, which is classified as “food” by a broad classification and “fruit” by a middle classification, and not extract “Jonagold”, which is classified as “variety” by a detailed classification in addition to these classifications. Further, in this case, the extraction section 203 may convert “Jonagold” into “fruit”, which is a middle classification, and extract “apple” as the extracted word 213. Further, the granularity may be set in advance for each classification. In this case, the extraction section 203 may extract, as the extracted word 213, a word for which a designated granularity is set.

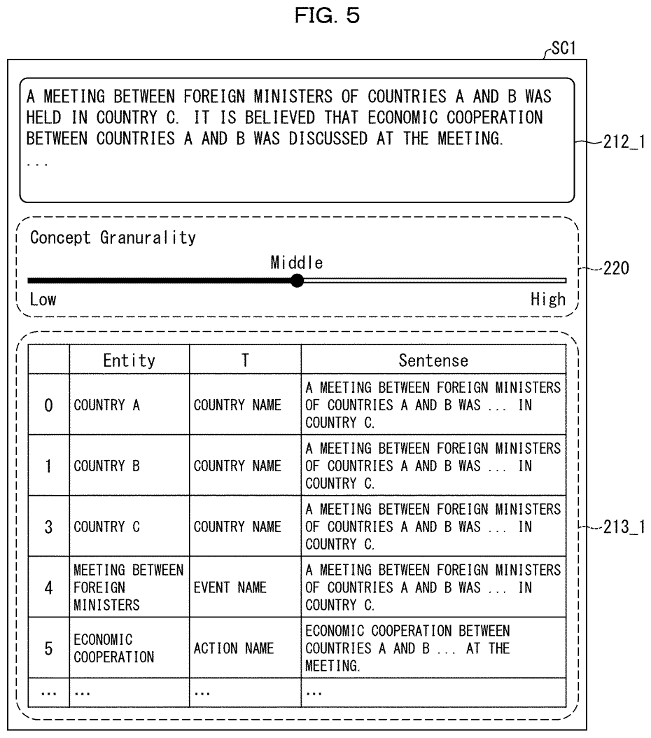

FIG. 5 is a view illustrating an example screen that allows a user to designate the designated granularity 211. A screen SC1 illustrated in FIG. 5 is displayed on, for example, an output apparatus (display) connected to the output section 23 or the communication section 24. The screen SC1 includes a target document 212_1, a slide bar 220, and an extracted word list 213_1.

The slide bar 220 is an object which allows a user to designate a designated granularity 211. The slide bar 220 on the screen SC1 allows a concept granularity to be selected by the following three levels of “low”, “middle”, and “high”. The user operates the slide bar 220 to designate a designated granularity 211. Of the words included in the target document 212_1, words that belong to a hierarchical level corresponding to the designated granularity 211 designated by the user are extracted and displayed on the screen SC1 as the extracted word list 213_1.

In a case where a plurality of types are classified in a hierarchical structure, the above-described whitelist may be prepared in advance for each hierarchical level, and the extraction section 203 may carry out extraction of the extracted word 213 with use of a whitelist corresponding to the designated granularity 211. Further, the blacklist may be prepared in advance for each hierarchical level, and the extraction section 203 may carry out extraction of the extracted word 213 with use of a blacklist corresponding to the designated granularity 211.

Further, the extraction section 203 may extract the extracted word 213 by combining a plurality of techniques. For example, the extraction section 203 may extract, as the extracted word 213, both an extracted word extracted with use of the document summarization model and an extracted word extracted by the technique of named entity recognition. Note that the technique in which the extraction section 203 extracts the extracted word 213 from the target document 212 is not limited to the above example, and the extraction section 203 may extract the extracted word 213 from the target document 212 by another technique.

On the extracted word list 213_1 on the screen SC1, a classification that is set for an extracted word and a sentence containing the extracted word in the target document 212_1 are displayed in addition to the extracted word. Since the classification and the sentence including the extracted word are displayed together with the extracted word, it is possible for a user to recognize what classification the extracted word belongs to and what context the extracted word is being used in, and to thereby easily select an extracted word that interests the user.

### Generation of Search Query

The following description will discuss a method by which the search query generation section 204 generates the search query 214. For example, the extracted word 213 extracted by the extraction section 203 may itself be used as the search query 214 by the search query generation section 204. Further, the search query generation section 204 may generate a search query 214 that includes the extracted word 213 and at least a part of N sentences (N is a natural number) around where the extracted word 213 occurs. In a case where N=1, the search query 214 includes the extracted word 213 and at least a part of the sentence containing the extracted word 213.

In the example illustrated in FIG. 3, a search query q1 includes “country A” as the extracted word 213 and a sentence containing “country A”. Further, the search query q2 includes “country B” as the extracted word 213 and a sentence containing “country B”. Further, the search query q3 includes “economic cooperation” as the extracted word 213 and a sentence containing “economic cooperation”.

### Retrieval of Related Document

The following description will discuss a method by which the related document retrieval section 205 retrieves the related document 215. The related document retrieval section 205 retrieves, with use of the search query 214, the related document 215 from a corpus including a plurality of documents. Note here that the corpus may include a reconstructed document which is generated by reconstruction of a document with use of an important word which is relatively high in importance among words included in the document. The important word, for example, may be a word to which a link is attached or a word to which a hashtag is attached among words included in the document. The important word may be, for example, a word extracted from information accompanying the document such as a document file property or an author name. The reconstructed document is, for example, a document in which important words are enumerated. The reconstructed document may be sentences constructed by supplementing important words with other words. The technique of generating sentences from words is not particularly limited, and for example, a known technique can be used.

Note that the corpus used by the related document retrieval section 205 may be one selected by a user. For example, in a case where the search query 214 is related to a news article, a user can select a corpus including news articles. Further, in a case where the search query 214 is related to a cooking recipe, a user can select a corpus including cooking recipes. In this way, since the user selects a corpus close to a characteristic of the search query, the related document retrieval section 205 can easily retrieve a document highly relevant to the search query.

The reconstructed document may be generated by the information processing apparatus 2 (for example, the related document retrieval section 205) or may be generated by another apparatus. That is, the reconstructed document is generated by any entity. Further, the reconstructed document may be generated by any method.

The related document retrieval section 205, for example, retrieves the related document 215 by a technique known as sparse retriever. That is, the related document retrieval section 205 considers a document having a high degree of overlapping of words between the search query 214 and the document to be the related document 215. Further, the related document retrieval section 205 may retrieve the related document 215 by a technique known as dense retriever. In this case, the related document retrieval section 205 vectorizes the search query 214 into an embedded vector and considers a document that is similar to the embedded vector in vector representation (a document close in inter-vector distance) to be the related document 215. Note that the technique in which the related document retrieval section 205 retrieves the related document 215 is not limited to the above example, and the related document retrieval section 205 may retrieve the related document 215 by another technique.

### Extraction of Candidate Words

The following description will discuss a method by which the candidate word extraction section 206 extracts the candidate words 216. The candidate word extraction section 206, for example, may extract the candidate words 216 from the related document 215 with use of the document summarization model disclosed in Non-Patent Literature 1 above. Further, the candidate word extraction section 206 may extract the candidate words 216 by the technique of named entity recognition. Extraction of the candidate words 216 by the technique of named entity recognition is similar to a technique in which the extraction section 203 extracts the extracted word 213 from the target document 212, and the description thereof will not be repeated here.

The candidate words 216 extracted from the related document 215 also include those extracted from accompanying information or structure information accompanying the related document 215. In other words, the candidate word extraction section 206 extracts, as the candidate words 216, important words which are relatively high in importance and identified on the basis of at least one of selected from the group consisting of: structure information indicative of a structure of the related document 215; and accompanying information which accompanies the related document 215. Note here that the structure information is, for example, information pertaining to a link attached to a word included in the related document 215. The more important a word is, the more likely it is that a link is attached to the word. As such, the candidate word extraction section 206 can extract important words as the candidate words 216 by considering a word having a link attached thereto to be a candidate word 216. Further, examples of the accompanying information encompass: meta-information such as a file property or an author name; and a hashtag. Note that the technique in which the candidate word extraction section 206 extracts the candidate words 216 is not limited to the above example, and the candidate word extraction section 206 may extract the candidate words 216 from the related document 215 by another technique. Note that the candidate words 216 may include a part or all of extracted words 213.

### Detection of Related Word

The following description will discuss a method of detecting a related word by the related word detection section 208. For example, the related word detection section 208 detects the related word 218 from among the candidate words 216 on the basis of the score 217 indicative of a relevance between the target document 212 and each of the candidate words 216. For example, the score 217 is a real number in a range of 0 to 1, and the closer the score 217 is to 0, the lower relevance is indicated, and the closer the score 217 is to 1, the higher relevance is indicated. However, the score 217 is not limited to such an example. For example, the related word detection section 208 may detect a candidate word 216 and a related word having a calculated score of not less than a threshold.

The score 217 is, for example, a score representing a distance between an embedded vector calculated from each of the candidate words 216 and an embedded vector calculated from the target document 212. Note here that the embedded vector calculated from each of the candidate words 216 may be obtained by directly vectorizing the candidate word 216, or may be a vector obtained by vectorizing a sentence containing the candidate word 216 or vectorizing the sentence and a sentence around the sentence.

Further, an embedded vector calculated from the target document 212 may be a vector obtained by vectorizing the target document 212 as it is, or may be a vector obtained by vectorizing a sentence which contains the extracted word 213 extracted from the target document 212.

Note that the embedded vector is a value calculated by an embedded model which represents given data in a vector space. The embedded model is a model in which data similarity is represented as a spatial distance.

Note that the method for training the embedded model is not limited to a specific one, and a general machine learning technique may be used. For example, the related word detection section 208 may use, as the embedded model, a model trained by a training algorithm using a multilayer neural network.

By using the embedded vector, the related word detection section 208 can calculate the score 217 taking account of a semantic similarity between each of the candidate words 216 and the target document 212.

Further, a method by which the related word detection section 208 calculates the score 217 is not limited to an embedded vector, and can be any method. For example, the related word detection section 208 may use an existing natural language processing technique such as syntactic analysis to vectorize the candidate words 216 and the target document 212 and calculate the score 217.

Further, as another example in which the score calculation section 207 calculates the score 217, for example, the score calculation section 207 may calculate the score 217 with use of a scorer which is used for calculation of a score indicative of a relevance between a search word and a website in a search engine. The scorer, for example, is a learned model generated by performing machine learning of a relevance between a search word and a website.

### Flow of Process

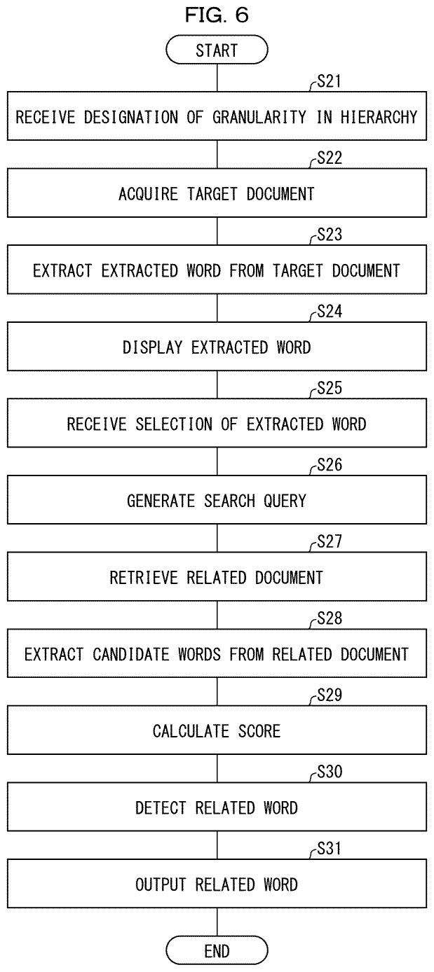

The following will describe, with reference to FIG. 6, a flow of a process (related word detection method) carried out by the information processing apparatus 2. FIG. 6 is a flowchart illustrating a flow of the process carried out by the information processing apparatus 2.

In S21, the reception section 201 receives designation of a granularity in a hierarchy and causes the granularity to be stored in the storage section 21 as the designated granularity 211. In S22, the target document acquisition section 202 acquires a target document and causes the target document to be stored in the storage section 21 as a target document 212. In S23, the extraction section 203 extracts an extracted word from the target document 212 and causes the extracted word to be stored in the storage section 21 as an extracted word 213.

In S24, the output control section 209 causes the extracted word 213 extracted from the target document 212 to be displayed on a display apparatus. In S25, the reception section 201 receives selection of the extracted word 213 displayed on the display apparatus.

In S26, the search query generation section 204 generates a search query with use of the extracted word 213 and causes the search query to be stored in the storage section 21 as a search query 214. In S27, the related document retrieval section 205 retrieves, with use of the search query 214, a related document from the corpus and causes the related document to be stored in the storage section 21 as a related document 215. In S28, the candidate word extraction section 206 extracts candidate words from the related document 215 and causes the candidate words to be stored in the storage section 21 as candidate words 216.

In S29, the score calculation section 207 calculates a score 217 for each of the candidate words 216. In S30, the related word detection section 208 detects a related word 218 from among the candidate words 216 on the basis of the score 217 calculated by the score calculation section 207.

In S31, the output control section 209 causes the display apparatus to provide display output of the related word 218 which has been detected by the related word detection section 208. The display apparatus may be an apparatus which is external to the information processing apparatus 3 and is connected to the input section 22 or the communication section 24, or may be an apparatus incorporated in the information processing apparatus 3. At this time, the output control section 209 causes the display apparatus to provide display output of the related word 218 extracted from the related document 215 retrieved with use of the selected extracted word 213 on the basis of selection received by the reception section 201 in S25.

Note that in a case where extracted words 213 are included among related words 218, the output control section 209 may output those of the related words 218 which are other than the extracted words 213, or may output all the related words 218 together including the extracted words 213 included among the related words 218. In the case of outputting both the extracted words 213 and the related words 218, it is preferable that the output control section 209 present the extracted words 213 and the related words 218 (words that are not included among the extracted words 213) in a manner that allows making a distinction between the extracted words 213 and the related words 218 by, for example, displaying the extracted words 213 in a manner different from a manner in which the related words 218 are displayed.

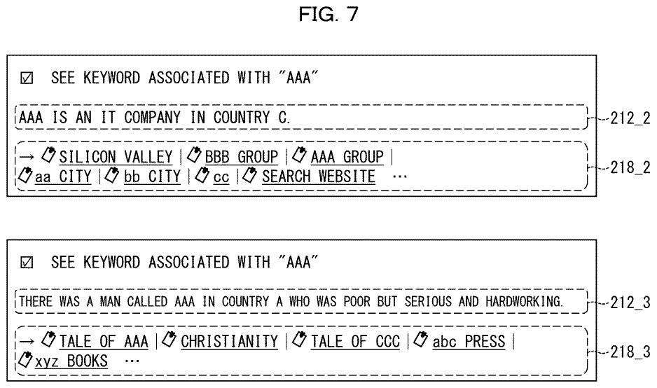

FIG. 7 is a view illustrating an example screen displaying related words 218, the example screen being outputted by the output control section 209. In FIG. 7, related words 218_2 are each a related word which is detected by the information processing apparatus 2 with respect to an extracted word “AAA” included in the target document. Note that the extracted word is a name of a character in a story, and the name is used also as a company name. 212_2 is a sentence which contains the extracted word in the target document. Related words 218 3 are each a related word which is detected by the information processing apparatus 2 with respect to the extracted word “AAA” included in another target document. 212_3 is a sentence which contains the extracted word in the target document. Note that, in the example screen illustrated in FIG. 7, related words are indicated as “associated keywords”.

As illustrated in FIG. 7, although the extracted word is the same, the related words 218_2 are different from the related words 218_3. Specifically, words corresponding to the fact that the extracted word is used as a company name are presented as the related words 218_2, whereas words corresponding to the fact that the extracted word is used as a character name of a story are presented as the related words 218_3. Thus, the information processing apparatus 2 makes it possible to extract, for the respective target documents 212_2 and 212_3, related words 218_2 and 218_3 which well capture the contexts of the target documents, including words that are not included in the target documents.

### Advantageous Effect of Information Processing Apparatus

According to the present example embodiment, the information processing apparatus 2 causes a display apparatus to display an extracted word 213 extracted from a target document 212 and, upon reception of selection of the displayed extracted word 213, causes the display apparatus to display a related word 218 extracted from a related document 215 retrieved with use of the extracted word 213 which has been selected. Note that output of the related word 218 may be carried out in any manner, and is not limited to display output. Thus, according to the information processing apparatus 2 in accordance with the present example embodiment, in a case where a user selects an extracted word 213 that interests the user among extracted words 213, a related word 218 related to the extracted word 213 which has been selected is outputted. That is, the information processing apparatus 2 makes it possible to easily collect knowledge related to a matter that

### Third Example Embodiment

The following description will discuss a third example embodiment of the present invention in detail with reference to drawings. Note that any constituent element that is identical in function to a constituent element described in the first example embodiment or the second example embodiment will be given the same reference numeral, and a description thereof will not be repeated.

### Configuration of Information Processing Apparatus 3

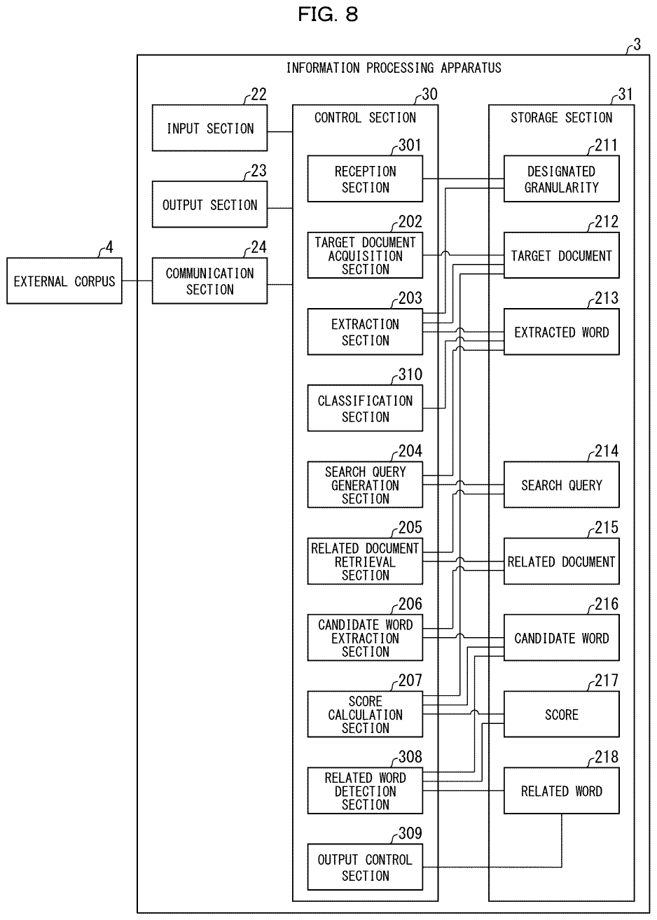

FIG. 8 is a block diagram illustrating an example configuration of an information processing apparatus 3 in accordance with the present example embodiment. As illustrated in FIG. 8, the information processing apparatus 3 includes a control section 30 which collectively controls sections of the information processing apparatus 3 and a storage section 31 in which various data used by the information processing apparatus 3 are stored. The information processing apparatus 3 also includes an input section 22, an output section 23, and a communication section 24.

The control section 30 includes a reception section 301, a target document acquisition section 202, an extraction section 203, a search query generation section 204, a related document retrieval section 205, a candidate word extraction section 206, a score calculation section 207, a related word detection section 308, an output control section 309, and a classification section 310. The storage section 31 stores therein a designated granularity 211, a target document 212, an extracted word 213, a search query 214, a related document 215, a candidate word 216, a score 217, and a related word 218.

Similarly as the reception section 201 in accordance with the second example embodiment described above, the reception section 301 receives designation of a granularity in a hierarchy used in an extraction process of extracting an extracted word 213 by the extraction section 203. The reception section 301 receives selection of one or a plurality of extracted words 213 extracted from a target document 212.

The output control section 309 causes an output apparatus to output a related word 218 related to the target document 212 and extracted from a related document 215 which is related to each of the one or plurality of extracted words 213 selected on the basis of the selection received by the reception section 301 and which is detected by a retrieval carried out with use of the each of the one or plurality of extracted words 213.

The classification section 310 classifies an extracted word 213. For example, the classification section 310 classifies an extracted word 213 by named entity classification. The classification section 310 may classify an extracted word 213 with use of a hierarchical structure or may classify an extracted word 213 without a hierarchy. The classification section 310 may be included in the extraction section 203.

The related word detection section 308 detects a related word 218 from among candidate words 216 extracted by the candidate word extraction section 206. Further, in a case where the reception section 301 receives collective selection of a plurality of extracted words 213, the related word detection section 308 detects, as a related word 218 and from among candidate words extracted from a plurality of related documents 215 detected by retrievals with use of the respective plurality of extracted words 213 collectively selected, at least one selected from the group consisting of: a candidate word 216 extracted in common from the plurality of related documents 215; and a candidate word 216 selected on the basis of a score indicative of a relevance between the target document 212 and the candidate word 216.

### Specific Example 1 of Display Output

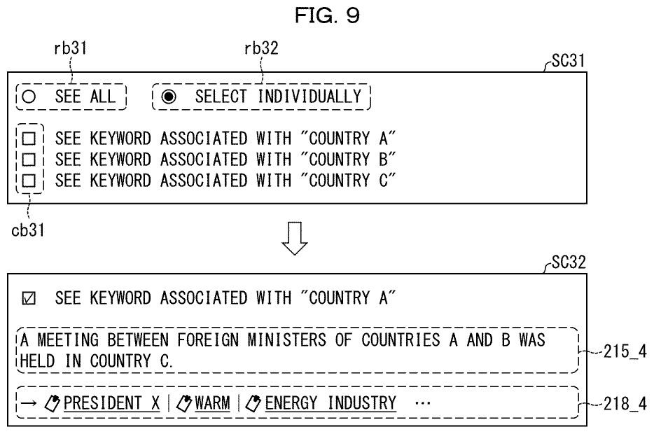

FIG. 9 is a view illustrating an example screen for receiving selection of an extracted word 213 and an example screen displaying a related word 218, the example screens being outputted by the information processing apparatus 3. The output control section 309 may cause a display apparatus to provide display output of such display screens. The display apparatus may be an apparatus which is external to the information processing apparatus 3 and is connected to the input section 22 or the communication section 24, or may be an apparatus incorporated in the information processing apparatus 3.

In a case where a target document 212 is acquired, the extraction section 203 extracts an extracted word 213 from the target document 212. Then, the reception section 301 causes the display apparatus to provide display output of a screen SC31 including the extracted word 213 as illustrated in FIG. 9. On the screen SC31, “country A”, “country B”, and “country C” are displayed as extracted words 213 extracted from the target document 212. Note here that the plurality of extracted words 213 displayed on the screen SC31 belong to the same classification. In other words, in the example of the screen SC31, the output control section 309 causes the display apparatus to provide collective display output of the plurality of extracted words 213 belonging to the same classification.

Further, the screen SC31 includes: a radio button rb31 for receiving collective selection of the plurality of extracted words 213 of which the collective display output is provided; and a radio button rb32 and checkboxes cb31 for receiving individual selection of an extracted word 213 among the plurality of extracted words 213 of which the collective display output is provided. In a case where the radio button rb31 is selected by a user operation, the reception section 301 receives collective selection of the plurality of extracted words 213 of which the collective display output is provided. In a case where the radio button rb32 and a checkbox cb31 are selected by a user operation, the reception section 301 receives individual selection of an extracted word 213 among the plurality of extracted words 213 of which the collective display output is provided.

In a case where the extracted word(s) 213 is/are selected, the search query generation section 204 generates a search query 214 with use of each of the selected extracted word(s) 213, the related document retrieval section 205 detects a related document 215 with use of the search query 214, and the candidate word extraction section 206 extracts candidate words 216 from the related document 215. Then, the score calculation section 207 calculates a score 217 of each of the candidate words 216, and the related word detection section 308 detects a related word 218 on the basis of the score 217.

Subsequently, the output control section 309 causes the display apparatus to provide display output of the related word 218. For example, in a case where “country A” is selected as an extracted word 213 on the screen SC31, the output control section 309 causes a screen SC32 illustrated in FIG. 9 to be displayed. The screen SC32 includes related words 218_4 extracted from a related document 215 retrieved by a retrieval conducted with use of “country A”. In other words, in a case where any one of the extracted words 213 is selected on the screen SC31, the output control section 309 causes the output apparatus to output related words 218_4 extracted from a related document 215 retrieved by a retrieval carried out with use of the extracted word 213 which has been selected, on the basis of the selection received by the reception section 301.

The screen SC32 also includes a sentence 251_4 extracted from the target document 212 and containing “country A”. In other words, the output control section 309 causes the output apparatus to output, together with the related word 218, a sentence extracted from the target document 212 and containing the extracted word 213.

In a case where the radio button rb31 is selected on the screen SC31 or in a case where a plurality of checkboxes cb31 are selected on the screen SC31 (i.e., in a case where a plurality of extracted words 213 are collectively selected), the output control section 309 causes the output apparatus to output related words 218_4 extracted from related documents 215 retrieved by retrievals carried out with use of the extracted words 213 which have been collectively selected. At this time, the related word detection section 308 may detect, as a related word 218 and from among candidate words 216 extracted from the plurality of related documents 215 retrieved by retrievals carried out with use of the respective extracted words 213 collectively selected, a candidate word 216 that is extracted in common from the plurality of related documents 215. Further, similarly as in the second example embodiment described above, the related word detection section 308 may detect a related word 218 on the basis of a score indicative of a relevance between the target document 212 and each of the candidate words 216. Note that the related word detection section 308 may take account of the score also in the case of detecting, as a related word 218, a candidate word 216 that is extracted in common. For example, the related word detection section 308 may detect, as a related word 218 and from among candidate words 216 each extracted in common from a plurality of related documents 215, a candidate word 216 having a score not lower than a threshold.

In other words, in a case where the reception section 301 receives collective selection of a plurality of extracted words 213, the related word detection section 308 detects, as a related word 218 and from among candidate words extracted from a plurality of related documents 215 detected by retrievals carried out with use of the respective plurality of extracted words 213 collectively selected, at least one selected from the group consisting of: a candidate word 216 extracted in common from the plurality of related documents 215; and a candidate word 216 selected on the basis of a score indicative of a relevance between the target document 212 and each of the candidate words 216.

### Specific Example 2 of Display Output

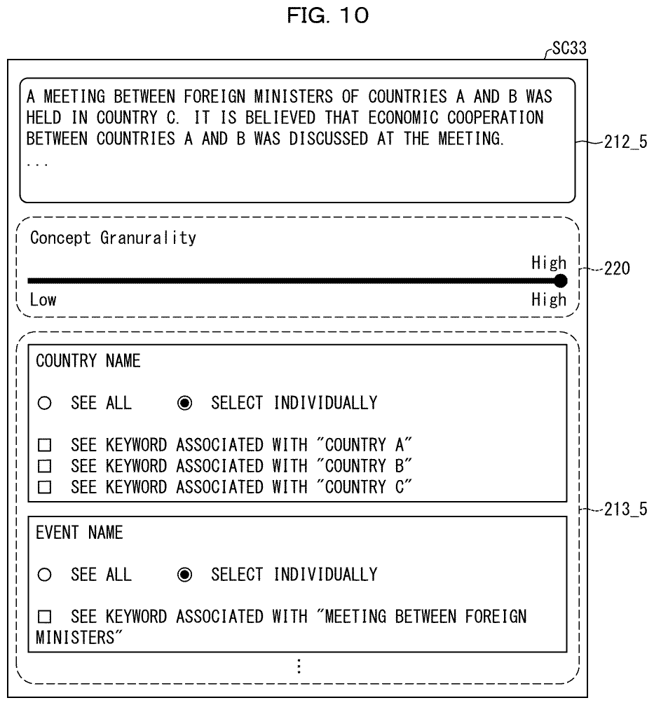

The following description will discuss another example of a screen for receiving selection of an extracted word 213, with reference to drawings. FIG. 10 is a view illustrating an example of a screen for receiving selection of an extracted word 213, the screen being outputted by the information processing apparatus 3. In this example, the classification section 310 classifies, in a hierarchical structure, a plurality of extracted words 213 extracted by the extraction section 203. Further, the reception section 301 receives designation of a granularity in a hierarchy, and the output control section 309 causes a display apparatus to provide collective display output of extracted words 213 which belong to the same classification in the designated granularity.

A screen SC33 illustrated in FIG. 10 includes a target document 212_5, a slide bar 220, and an extracted word 213_5. The slide bar 220 is an object which allows a user to designate a granularity in a hierarchy. The user operates the slide bar 220 to designate the granularity in a hierarchy. That is, the reception section 301 receives designation of the granularity by the slide bar 220. On the screen SC33, among extracted words 213 extracted from the target document 212_5, extracted words 213_5 belonging to the same classification in the granularity designated by the user with use of the slide bar 220 are collectively displayed.

For example, in a case where a high granularity is designated (for example, in a case where “High” is designated on the slide bar 220 on the screen SC33 illustrated in FIG. 10), the output control section 309 causes extracted words 213 classified with the high granularity to be outputted by display output. For example, as on the screen SC33, extracted words 213 for which a broad classification such as “country name” or “event name” is set are collectively displayed on a classification-by-classification basis.

In contrast, in a case where a low granularity is designated, the output control section 309 causes extracted words 213 classified with the low granularity to be outputted by display output. For example, the output control section 309 may cause extracted words 213 that belong to the same detailed classification to be collectively outputted by display output.

A process carried out in a case where an extracted word(s) 213 which is/are displayed on the screen SC33 illustrated in FIG. 10 is/are selected is similar to that in the above-described specific example 1. That is, in a case where any one of the extracted words 213 is selected on the screen SC33, the output control section 309 causes a display apparatus to provide display output of a related word 218 extracted from a related document 215 retrieved by a retrieval carried out with use of the selected extracted word 213, on the basis of the selection received by the reception section 301. Or, in a case where the plurality of extracted words 213 are collectively selected on the screen SC33, the output control section 309 causes the display apparatus to provide display output of related words 218 extracted from related documents 215 retrieved by retrievals carried out with use of the collectively selected plurality of extracted words 213.

### Advantageous Effect of Information Processing Apparatus

As described above, the information processing apparatus 3 in accordance with the present example embodiment employs a configuration in which: the output apparatus which outputs a related word 218 is a display apparatus; the output control section 309 causes the display apparatus to produce collective display output of a plurality of extracted words 213 belonging to the same classification; and the reception section 301 receives collective selection of the plurality of extracted words 213 which are collectively outputted by display output.

According to the above configuration, the user can (i) collectively check a plurality of extracted words 213 belonging to the same classification, (ii) collectively select a group of extracted words that interests the user, and (iii) check a related word 218 corresponding to the group of extracted words.

Further, the information processing apparatus 3 in accordance with the present example embodiment employs a configuration in which: a plurality of extracted words 213 are classified in a hierarchical structure; the reception section 301 receives designation of a granularity in a hierarchy, and the output control section 309 causes the display apparatus to provide collective display output of extracted words 213 which belong to the same classification in the designated granularity.

According to the above configuration, a user is able to receive presentation of extracted words 213 in a state where the extracted words 213 are gathered together in accordance with the granularity desired by the user.

Further, the information processing apparatus 3 in accordance with the present example embodiment employs a configuration in which the information processing apparatus 3 includes the related word detection section 308 which, in a case where the reception section 301 receives collective selection of a plurality of extracted words 213, the related word detection section 308 detects, as a related word 218 and from among candidate words 216 extracted from a plurality of related documents 215 detected by retrievals with use of the respective plurality of extracted words 213 collectively selected, at least one selected from the group consisting of: a candidate word 216 extracted in common from the plurality of related documents 215; and a candidate word 216 selected on the basis of a score indicative of a relevance between the target document 212 and each of the candidate words 216.

In a case where a candidate word extracted in common from the plurality of related documents 215 is detected as a related word, it is possible to present to the user a related word 218 that is related to all of the extracted words 213 collectively selected. Further, in a case where a candidate word 216 selected on the basis of a score indicative of a relevance between the target document 212 and each of the candidate words 216 is detected as a related word 218, it is possible to present to the user a related word 218 that is highly relevant to the target document 212.

Further, the information processing apparatus 3 in accordance with the present example embodiment employs a configuration in which the output control section 309 causes the output apparatus to output, together with the related word 218, a sentence extracted from the target document 212 and containing the extracted word 213.

This configuration provides an advantageous effect that it is possible to have a related word 218 checked while taking account of a context in which the extracted word 213 is used.

### Variation

The processes described in the example embodiments above may be carried out by any entity, not confined to the above-described examples. That is, a related word output system having functions similar to those of the information processing apparatus 2 can be constructed by a plurality of apparatuses capable of communicating with each other. For example, a related word output system having functions similar to those of the information processing apparatus 2 can be constructed by dispersedly providing, in a plurality of apparatuses, blocks illustrated in FIG. 8. For example, the reception of selection of an extracted word and the output of a related word may be carried out by respective different apparatuses. Further, the processes included in the flow in FIG. 6 may be carried out by a plurality of apparatuses (processors).

### Software Implementation Example

Some or all of the functions of each of the information processing apparatuses 1, 2, and 3 may be implemented by hardware such as an integrated circuit (IC chip), or may be alternatively implemented by software.

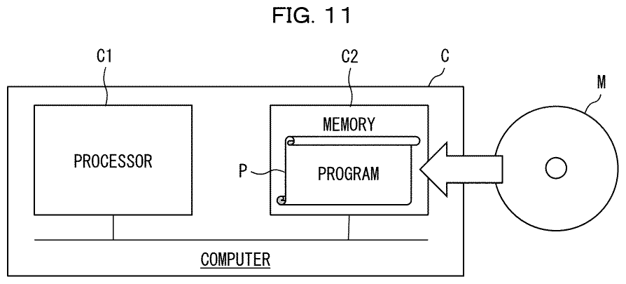

In the latter case, the information processing apparatuses 1, 2, and 3 are each realized by, for example, a computer that executes instructions of a program that is software realizing the foregoing functions. FIG. 11 illustrates an example of such a computer (hereinafter referred to as “computer C”). The computer C includes at least one processor C1 and at least one memory C2. The at least one memory C2 stores a program P (related word output program) for causing the computer C to operate as the information processing apparatus 1, 2, or 3. In the computer C, the functions of the information processing apparatus 1, 2, or 3 are realized by the processor C1 reading the program P from the memory C2 and executing the program P.

The processor C1 may be, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof. The memory C2 may be, for example, a flash memory, a hard disk drive (HDD), a solid state drive (SSD), or a combination thereof.

Note that the computer C may further include a random access memory (RAM) in which the program P is loaded at the time of execution and in which various data are temporarily stored. The computer C may further include a communication interface for carrying out transmission and reception of data to and from another apparatus. The computer C may further include an input-output interface via which input-output equipment such as a keyboard, a mouse, a display or a printer is connected.

The program P can also be recorded in a non-transitory tangible recording medium M from which the computer C can read the program P. Such a recording medium M can be, for example, a tape, a disk, a card, a semiconductor memory, a programmable logic circuit, or the like. The computer C can acquire the program P via the recording medium M. The program P can be transmitted via a transmission medium. Examples of such a transmission medium can include a communication network and a broadcast wave. The computer C can acquire the program P also via the transmission medium.

### Additional Remark 1

The present invention is not limited to the above example embodiments, but may be altered in various ways by a skilled person within the scope of the claims. For example, the present invention also encompasses, in its technical scope, any example embodiment derived by appropriately combining technical means disclosed in the foregoing example embodiments.

The whole or part of the example embodiments disclosed above can also be described as below. Note, however, that the present invention is not limited to the following supplementary notes.

### Supplementary Note 1

An information processing apparatus, including: a reception means that receives selection of one or a plurality of extracted words extracted from a target document; and an output control means that causes an output apparatus to output a related word related to the target document and extracted from a related document, the related document being related to each of the one or plurality of extracted words selected and being detected by a retrieval with use of the each of the one or plurality of extracted words.

### Supplementary Note 2

The information processing apparatus described in supplementary note 1, wherein: the output apparatus is a display apparatus; the output control means causes the display apparatus to provide collective display output of a plurality of extracted words belonging to the same classification; and the reception means receives collective selection of the plurality of extracted words of which the collective display output is provided.

### Supplementary Note 3

The information processing apparatus described in supplementary note 2, wherein: a plurality of extracted words are classified in a hierarchical structure; the reception means receives designation of a granularity in a hierarchy; and the output control means causes the display apparatus to provide collective display output of extracted words belonging to the same classification in the granularity designated.

### Supplementary Note 4

The information processing apparatus described in supplementary note 2, further including a related word detection means that, in a case where the reception means receives the collective selection of the plurality of extracted words, detects, as the related word and from among candidate words extracted from a plurality of related documents detected by retrievals with use of the respective plurality of extracted words collectively selected, at least one selected from the group consisting of: a candidate word extracted in common from the plurality of related documents; and a candidate word selected on the basis of a score indicative of a relevance between the target document and each of the candidate words.

### Supplementary Note 5

The information processing apparatus according to any one of supplementary notes 1 to 4, wherein the output control means causes the output apparatus to output a sentence together with the related word, the sentence being extracted from the target document and containing the one or plurality of extracted words.

### Supplementary Note 6

A related word output method, including: receiving, by at least one processor, selection of one or a plurality of extracted words extracted from a target document; and causing, by the at least one processor, an output apparatus to output a related word related to the target document and extracted from a related document, the related document being related to each of the one or plurality of extracted words selected and being detected by a retrieval with use of the each of the one or plurality of extracted words.

### Supplementary Note 7

A related word output program for causing a computer to function as: a reception means that receives selection of one or a plurality of extracted words being extracted from a target document; and an output control means that causes an output apparatus to output a related word related to the target document and extracted from a related document, the related document being related to each of the one or plurality of extracted words selected and being detected by a retrieval with use of the each of the one or plurality of extracted words.

### Additional Remark 3

The whole or part of the example embodiments disclosed above can also be expressed as follows.

An information processing apparatus, including at least one processor, the at least one processor carrying out: a reception process of receiving selection of one or a plurality of extracted words extracted from a target document; and an output control process of causing an output apparatus to output a related word related to the target document and extracted from a related document, the related document being related to each of the one or plurality of extracted words selected and being detected by a retrieval with use of the each of the one or plurality of extracted words.

Note that the information processing apparatus may further include a memory, which may store therein a program for causing the at least one processor to carry out the reception process and the output control process. The program can be stored in a computer-readable non-transitory tangible storage medium.
1, 2, 3: Information processing apparatus
11, 201, 301: Reception section
12, 209, 309: Output control section
308: Related word detection section
310: Classification section

What is claimed is:

1. An information processing apparatus, comprising at least one processor, the at least one processor carrying out:
a reception process of receiving selection of one or a plurality of extracted words among a plurality of extracted words extracted from a target document; and
an output control process of causing an output apparatus to output a related word related to the target document and extracted from a related document, the related document being related to each of the one or plurality of extracted words selected and being detected by a retrieval with use of the each of the one or plurality of extracted words.

2. The information processing apparatus according to claim 1, wherein:
the output apparatus is a display apparatus;
in the output control process, the at least one processor causes the display apparatus to provide collective display output of a plurality of extracted words belonging to the same classification among the plurality of extracted words extracted from the target document; and
in the reception process, the at least one processor receives collective selection of the plurality of extracted words of which the collective display output is provided.

3. The information processing apparatus according to claim 2, wherein:
a plurality of extracted words are classified in a hierarchical structure;
the at least one processor receives designation of a granularity in a hierarchy; and
in the output control process, the at least one processor causes the display apparatus to provide collective display output of extracted words belonging to the same classification in the granularity designated.

4. The information processing apparatus according to claim 2, wherein the at least one processor further carries out a related word detection process of, in a case where the at least one processor receives in the reception process the collective selection of the plurality of extracted words, detecting, as the related word and from among candidate words extracted from a plurality of related documents detected by retrievals with use of the respective plurality of extracted words collectively selected, at least one selected from the group consisting of: a candidate word extracted in common from the plurality of related documents; and a candidate word selected on the basis of a score indicative of a relevance between the target document and each of the candidate words.

5. The information processing apparatus according to claim 1, wherein in the output control process, the at least one processor causes the output apparatus to output a sentence together with the related word, the sentence being extracted from the target document and containing the one or plurality of extracted words.

6. A related word output method, comprising:
receiving, by at least one processor, selection of one or a plurality of extracted words extracted from a target document; and
causing, by the at least one processor, an output apparatus to output a related word related to the target document and extracted from a related document, the related document being related to each of the one or plurality of extracted words selected and being detected by a retrieval with use of the each of the one or plurality of extracted words.

7. A computer-readable, non-transitory storage medium storing a related word output program for causing a computer to function as:
a reception means that receives selection of one or a plurality of extracted words extracted from a target document; and
an output control means that causes an output apparatus to output a related word related to the target document and extracted from a related document, the related document being related to each of the one or plurality of extracted words selected and being detected by a retrieval with use of the each of the one or plurality of extracted words.
